(19) United States
(12) Patent Application Publication
(10) Pub. No.: US 2026/0364492 A1
(43) Pub. Date: Nov. 19, 2026

(54) Extraction Process

(71) Applicant: Ian LaMontagne, Aurora, CO (US)

(72) Inventor: Ian LaMontagne, Aurora, CO (US)

(21) Appl. No.: 19/394,217

(22) Filed: Nov. 19, 2025

Related U.S. Application Data
(60) Provisional application No. 63/723,301, filed on Nov. 21, 2024.

(51) Int. Cl. B01D 21/28

(52) U.S. Cl. CPC B01D 21/28

(57) ABSTRACT

An method and corresponding system for extracting a substance by applying waves to plant matter in a liquid mixture to dislodge the substance and extract it. The waves may include sonic waves which may be applied to aqueous mixture containing the plant matter which may be held at low temperatures.

### PRIOR APPLICATION INFORMATION

This application claims the benefit of previously filed provisional application U.S. Application No. 63/723,301 which was filed on 21 Nov. 2024.

### BACKGROUND

Mechanical and chemical methods are used to process plant matter and extract from them various plant parts or compounds. For example, botanical extraction using grain alcohol has been used for centuries.

One such plant matter includes trichomes, which are outgrowths on plant matter that create certain metabolite compounds called bioflavonoids, commonly consumed by humans. Trichomes are present in many plants and algae, including in the cannabis plant. Some types include structures that secrete oils, resins, or flavonoids. Trichomes, including glandular trichomes, are extracted by solvents such as butane and ethanol.

Extracting using such solvents is not desirable due to the concerns regarding solvent residue left behind. Those who prefer not to use these solvents may extract trichomes using a mechanical process which includes placing the cannabis in ice-cold water, causing the trichomes to break off from the plant. The ice-water mixture is then screens with fine mesh to collect the trichomes.

But this method is inefficient and therefore costly at scale. Accordingly, a solvent-free extraction method which is efficient and effective, for separation of trichomes from the cannabis plant, is needed.

### SUMMARY OF THE INVENTION

The present disclosure discloses a method and corresponding system which may be used for removal of trichomes from cannabis. The method and system are not limited to trichomes or the cannabis plant and may be used to remove any plant matter or compound which separates from its botanical based using the foregoing system and method. For example, the method may also be used on hops to extract their trichomes.

When used to extract trichomes from cannabis, the present method and system preserve the spectrum of the cannabinoids and terpenes contained in the trichomes and results in a complete, pure, and clean extraction. This extraction preserves the herbal and medicinal attributes of the cannabis trichome. Its purity and cleanness provide for a product that is free from the harmful residue associated with solvent use. Moreover, the method and system are effective, fast, and low cost thereby enabling a commercially efficient and desirable process for botanical extractions.

### BRIEF DESCRIPTION OF DRAWINGS

FIG. 1 is flow chart of the steps according to one embodiment of a method for separating the extraction from its plant base.

FIG. 2A is a depiction of a liquid mixture in a soaking vessel with a cooling bath.

FIG. 2B is a depiction of another embodiment of a liquid mixture in a soaking vessel with coolant circulation.

FIG. 2C is a depiction of another embodiment of a liquid mixture in a soaking vessel with coolant circulation.

FIG. 3 is a depiction of a liquid mixture with a sonotrode inserted into the liquid.

FIG. 4 is a depiction of a portion of one embodiment of a system with a sonotrode.

FIG. 5 is a diagram of one embodiment of the system according to the present disclosure.

FIG. 6 is an illustration of a pump.

### DETAILED DESCRIPTION

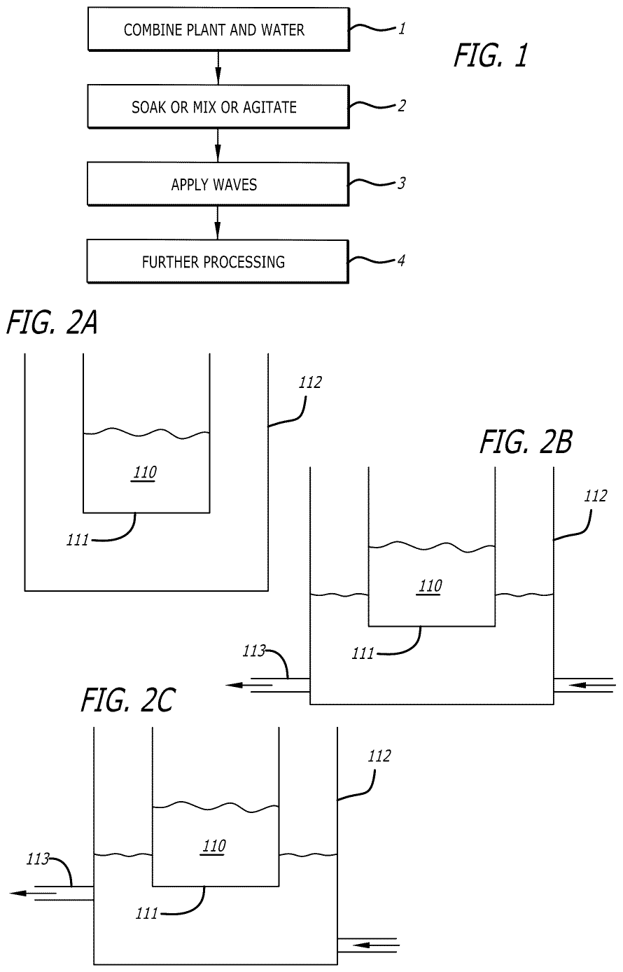

The present process includes a method and the corresponding system for implementing it. The processing method includes several stages some of which are shown in the flow chart of FIG. 1. The foregoing method and system are set forth concisely to better disclose the inventions herein. Therefore, they may omit extra details when not necessary to convey this understanding. They may also disclose multiple alternatives and embodiments aimed at improving this understanding. Accordingly, the disclosed invention is not limited by the foregoing explanations, rather illuminated by the full scope of what it teaches to a person having ordinary skill in the art.

Referring to FIG. 1, in Step 1, an aqueous liquid is created by mixing plant material with water. While the embodiments described in FIGS. 1-5 are described with respect to aqueous solutions, the liquid mixture need not be water-based. The plant material may include whole plants or portions thereof. For trichome extraction from cannabis, the plant matter may be cannabis, hemp branches, buds, or other plant parts. The plant material may be fresh or dried. They may be whole, chopped, ground, or otherwise cut or crushed. Moreover, derivatives of the plant matter including pre-processed plant material, hash, or other derivative may be included. The plant matter and water are combine to create a mixture or aqueous liquid.

The liquid in Step 1 may be any liquid that will not combine with the desired end product, forming a solution, via polar or nonpolar bonds, including covalent bonds. It may be regular water, spring water, distilled water, or a combination of water and ice. As a practical example, the primary bioactive compounds of cannabis, THC and CBD, are both non-polar compounds. Therefore, to extract the trichomes using the present liquid, a liquid that is of a polar nature, such as water, isopropanol, etc., may be used. The resulting mixture would then be heterogeneous in nature and would not become a solution. To extract compounds whose molecules are polar, a non-polar liquid may be used.

In one embodiment, the temperature of the liquid, which is water in the case of the embodiment of FIG. 1, is between about 0 to about 150 degrees Fahrenheit. The water may be provided in the desired temperature range. Alternatively, the aqueous liquid may be cooled or heated to reach a desired temperature within the desired range.

The aqueous liquid of Step 1 may be implemented in a soaking vessel. In accordance with Step 2, the aqueous liquid is left in the soaking vessel to soak undisturbed or it may be mixed or agitated while soaking. The soaking vessel may be of any desirable shape or size based on the amount of material to be processed, processing time, or other logistical considerations such as space. It may be covered or uncovered. It may be equipped with known mixing appendages such as mixing hooks, blades, wheels, or agitating mechanisms including propellers, vibrators, or circulating pumps. These appendages may be fixed within or to the vessel or may be inserted and removed from the vessel as desired.

Mixers can include a spectrum of methods from low shear mixing methods, such as magnetic stirrers, to high shear blenders. With cannabis, use of a high shear mixing method may result in some contamination or bursting of plant material. Alternatively, high shear methods might prove useful for production processes where high yield is a priority and quality of product is not.

Optionally, the aqueous liquid may be chilled in Step 1. For cannabis trichome separation, chilling the liquid assists in preservation of terpene and provides for a very high-quality end product. Chilling may be performed by chilling the vessel with known means or by simply adding ice to the liquid. The vessel or liquid may be chilled with any known method including circulation of refrigeration fluid outside the vessel or inside the vessel.

In one simple system, according to FIG. 2A, the soaking vessel 111 containing the aqueous liquid 110 is situated in a larger outer vessel 112. Ice-water or cooled fluid may be introduced into the outer fluid creating an ice bath for the aqueous liquid.

In FIG. 2B, the outer vessel 112 is coupled with a refrigerant system 113 which cools the outer vessel by heat transfer. The outer vessel may be open or sealed. Alternatively, the refrigerant system may be directly coupled to vessel 111. Further still, the refrigerant system may include a cooling jacket or pipes with refrigerant. FIG. 2C is an alternative configuration for a refrigerant system where the refrigerant is circulated around and outside the vessel 111 around the perimeter of the vessel.

Again with reference to FIG. 1, the plant matter will disperse in the water. This step can be sped up by mincing the plant matter and blending the aqueous liquid with mechanical methods such as using a high-speed blade. Smaller plant particles include the plant matter surface area which may be exposed to the liquid and may be processing by sound waves as described more fully below.

Once the mixture is blended, according to Step 3, waves are provided to the mixture. In the embodiment detailed below, the waves are sonic waves. Piezoelectric crystals and ceramics may be used to generate sonic waves. In one embodiment, ultrasonic ranges may be used. Alternatively, low frequency sound waves, for example from about 20 hertz to 200 hertz in frequency, may be used. Alternatively, infrasound may be used. Some advantages to this may include less energy transfer to the aqueous mixture during processing, leading to potential increase in quality and ability to extract heat sensitive terpenes.

In other embodiments, electromagnetic waves, for example in the range of 10³ to 10⁻⁵ meter wave lengths, may be used alone or in combination with sound waves. Electromagnetic waves may be produced, for example, by a radio frequency generator or by a microwave source. The electromagnetic waves may be applied during, prior to, or after application of the sonic waves.

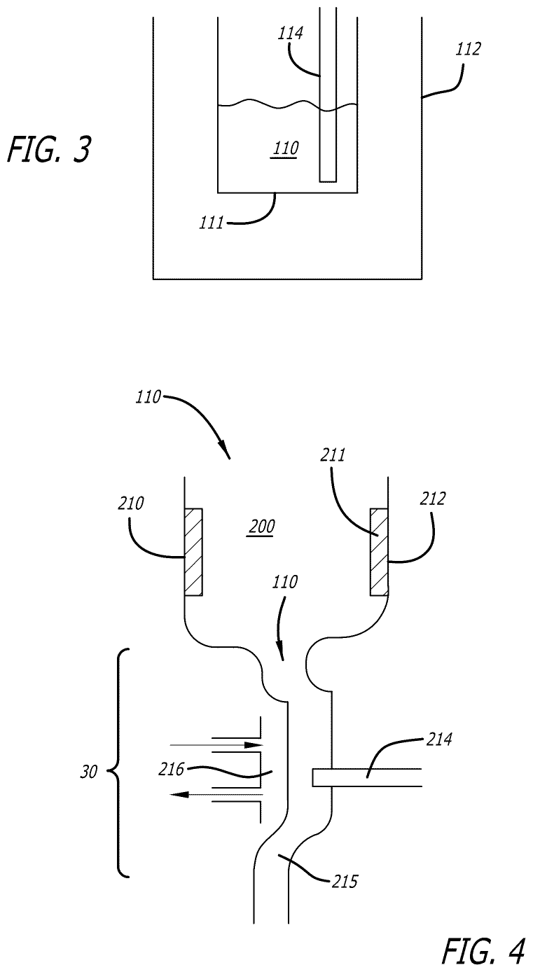

In one embodiment, the sonotrode may be inserted into the aqueous liquid as shown in FIG. 3. Sonotrode 114 is lowered into the aqueous liquid in vessel 111 and activated to generate sonic waves within the liquid. In some embodiments, the sonotrode is operated to produce sonic waves in the frequency range of about 5-35 kHz, depending on processing needs.

Introducing sonic energy into the aqueous liquid may raise the temperature of the liquid. According to one embodiment, the temperature of the aqueous liquid is maintained at or below about 50 degrees Fahrenheit during Steps 2 and 3. In other embodiments, the temperature may be higher. Higher temperatures are expected to affect the trichome profiles that respond or separate easier at higher temperatures. Accordingly, by controlling the temperature during these steps, a specific type of trichome may be extracted. Therefore, one factor in determining the temperature includes consideration of plant attributes and genetic factors which would inform the desired trichome profile for extraction. The temperature of the aqueous liquid may be monitored and controlled by known means such as temperature sensors and feedback.

Step 3 may last as long as desired to achieve the desired trichome separation. In the embodiments described, the time for Step 3 may vary from 1 to about 480 minutes. In alternative embodiments, the aqueous Step 2 may occur during Step 3. Accordingly, the liquid may continue to be mixed or agitated while the sonotrode is emitting sonic waves. In the embodiment of FIG. 3, the speed of the mixing is set prior to insertion of the sonotrode. Alternatively, it may be varied over time while the sonotrode is active. In one embodiment, the aqueous liquid may be stirred during application of the waves, creating beat frequencies in the mixture. The beat frequency may be audible and may change as the revolutions of the aqueous liquid change.

In an alternative embodiment, the aqueous liquid may be cooled or supercooled before being subject to the wave application. In the embodiment of FIG. 4, aqueous liquid 110 is pumped to a cooling chamber 200. Chamber 200 is coupled to a cooling system 210. Although, any of the various cooling systems and methods described above may also be used. In the embodiment of FIG. 4, the cooling system 210 includes pipes 211 which contain coolant 212. In this embodiment, the coolant is liquid nitrogen. Alternatively, it can be a glycol cooling system, use dry ice, or use other types of coolants.

By controlling the size of the chamber 200, its proportions to the cooling surface on system 210, and type of coolant 212, the process can be designed to provide a certain rate of cooling which would cool the aqueous liquid 110 to a desired temperature as it moves through the system. It may be done slower or faster depending on the specific rate of cooling that the system 210 can provide which in turn depends on the specific design as noted above.

When the system of FIG. 4 is designed so that the aqueous liquid moves continuously through, the process is a continuous process. Alternatively, valves may be installed in the system that process the aqueous liquid in a batch manner. That is, for example, the aqueous liquid would be held in the chamber 200 until it reaches the desired temperature. A sensor would detect the temperature and open a value (not shown) to allow the aqueous liquid to leave chamber 200 after it reaches the desired temperature.

As the cooled aqueous liquid moves out of chamber 200 and past sonotrode 214, it is subject to the sonic waves as described above. Once past stage 30 which corresponds to Step 3 in FIG. 1, the liquid may be directed for further processing. The further processing may be performed continuously or in batch mode.

In the embodiment as shown in FIG. 4, no agitation occurs in Step 3. But as described earlier, agitation at this stage may be incorporated into the process. One way to create such agitation is by placing mixing blades or propellers (not shown) in the path 215 of the aqueous liquid as it leaves the chamber 200. Alternatively, the exit to chamber 200 may be designed which a shape that creates a funnel in the aqueous liquid. Alternatively, it may incorporate protuberances or edges to create turbulence or shear in the aqueous liquid as it flows by. Moreover, even though the cooling system 210 is depicted in FIG. 4 to be coupled to the chamber 200, it may extend below the chamber to provide cooling along path 215.

Physical obstructions can also be added to the chamber to increase the amount of time it takes for the material to pass through it, increasing the time that the plant material is exposed to the sonotrode 214. This implementation may decrease the overall process time and increasing yield.

The physical obstructions can be in the form of rings, plates, or surfaces of metal, including aluminum or stainless steel, with holes formed into them. These holes may be designed, by selection of their shape, size, density, or distribution pattern, to optimize the flow. They may restrict the flow to a desired level without becoming clogged by plant material. Additionally, these holes could be drilled at an angle to induce a vortex into the passing liquid, which may then create a tumbling motion for plant materials passing through and further optimizing the exposure time of the plant materials to element 214.

FIG. 4 may be incorporated into a continuous flow system which is capable of higher throughputs and appropriate for larger scale manufacturing. The liquid mixture flows through the vessel portion at stage 30 and past the sonotrode, allowing for relatively continuous processing. With this continuous flow, more throughput may be achieved and the system may be more efficient. This design may incorporate baffles, restriction disks, or other physical implements to increase the time that the liquid mixture remains inside of the vessel as shown in FIG. 4.

In FIG. 4, cooling system 216 provides cooling, such as by using liquid nitrogen, dry ice, or a glycol loop, to cool a portion of path 215. System 216 and 210 may be integral or separate. Moreover, system 216 may extend along the entirety of path 215 or only a portion thereof. Additionally, it may use alternative configurations such as those already described with respect to cooling systems 113 or 210.

Referring back to FIG. 1, in Step 4, the application of waves and any mixing or agitation is concluded. The aqueous liquid may then receive further processing. Further processing may occur in the soaking vessel, or the liquid may be piped or transported to other locations for further processing. The process may be performed in batch or as a continuous flow.

Further processing may include filtering, heating, or other refinement techniques designed to further separate the trichomes from the plant base and to extract the trichomes from the aqueous liquid. In one embodiment, the aqueous liquid is passed through a series of decreasing size micron filters in order to extract the different grades of trichomes. The different grade trichomes may be used as desired. Alternatively, the different grade trichomes may be further processed for refinement by application of heat and pressure.

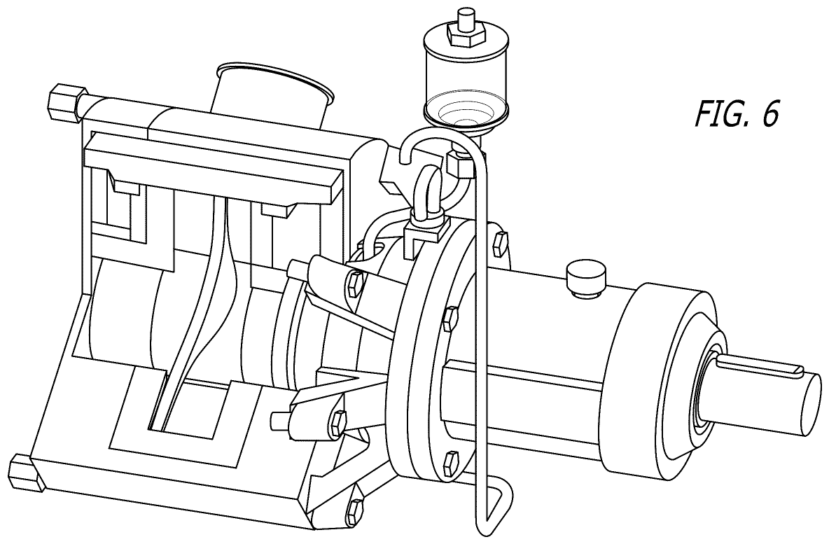

Movement of the liquid may be facilitated by a pump, for example as shown in FIG. 6. The pump may be capable of handling solids of up to 0.75 inches in diameter. The pump may be low shear. In one embodiment, the pump is a sinusoidal wave pump, for example an SP-1 Masosine pump manufactured by Watson-Marlow. The pump may have ultra-low sheer action and operate by opening and closing of chambers in a sinusoidal pattern which are driven by a sine-wave rotor and a sliding exit port seal. Use of such a design reduces clogging, which in turn prevents damage to the harvested plant materials and the trichome heads circulating in the liquid. One example of such a pump is shown in FIG. 6. Other pumps which are low shear and provide adequate ability to manage solid in the liquid may also be used. Some examples may include hose pumps, air diaphragm pumps, rotary screw pumps, or lobe pumps.

In one example, the trichomes may be subjected to processes such as freeze drying for the removal of remaining moisture and contaminants. In another example, heat varying between 120-250 degrees Fahrenheit and pressures varying from 50-1000 psi may be applied. In another example, they may be subjected to further mechanical processes such as being subjected to a centrifugal force. The forces involved with this can vary from 50 RCF (rotational centrifugal force) to 20000 RCF.

Alternatively, they may be subject to chemicals to form other products such as rosin, resin, oil, or a solution. In one example, the trichomes may be combined with chemicals such as isopropanol, ethanol, methanol, etc.

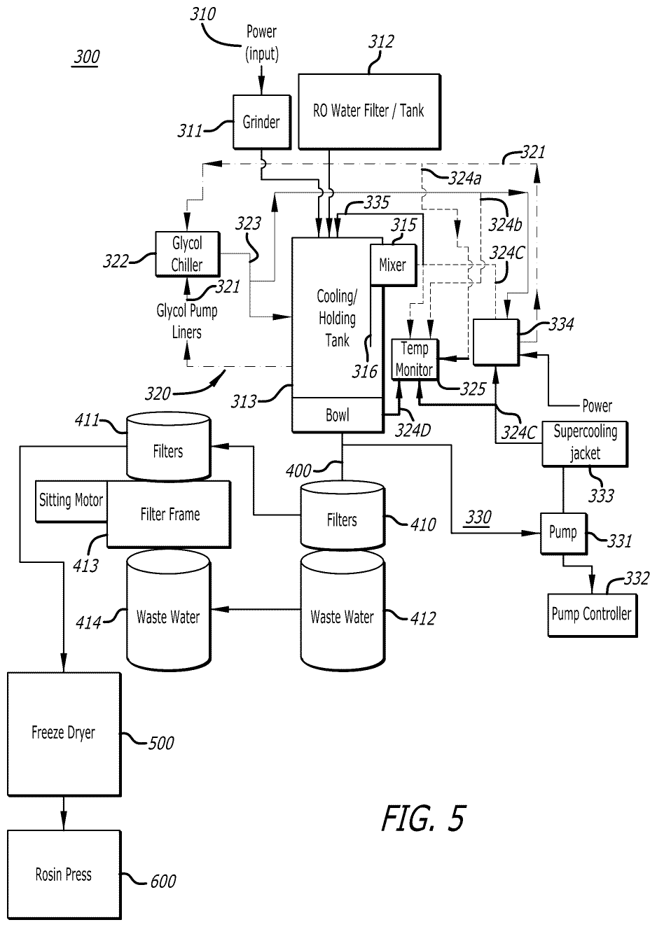

FIG. 5 shows one embodiment of a batch processing system 300 according to the present teachings. Plant matter 310 is deposited into grinder 311. The ground plant matter is placed in vessel 313 along with water from tank 312 of filtered water. The plant matter and water are combined to create aqueous liquid 314 contained in the vessel 313. In one embodiment, the aqueous liquid is cooled until the temperature of the aqueous liquid 314 reaches from about −40 Fahrenheit to about −50 Fahrenheit. Alternative processing temperatures as described above are also contemplated.

In one embodiment, as shown in FIG. 5, the grinder is a low shear grinder at a speed of less than about 250 RPM. These grinding parameters prevent the plant matter from heating up due to the grinding process.

Mixer 315 includes a mixing tip 316 which is submersed in the aqueous liquid. Vessel 313 is cooled by cooling system 320. System 320 utilizes a chilling jacket which provides glycol coolant to the outside of the vessel 313 to cool the aqueous liquid. Returned cooling fluid is pumped in lines 321 to heat exchanger or cooler 322. The chilled coolant is pumped back to the cooling jacket in lines 323. Alternatives cooling systems as described above are also contemplated.

The temperature of the coolant and the cooling system is monitored by temperature sensors at locations 324a-324e. The temperature may be measured at different locations and fewer locations may be monitored. The particular configuration presented is one embodiment as disclosed herein. The temperature measurements are transmitted in a wired or wireless manner to temperature monitor 325.

Monitor 325 may simply display the temperatures or may include processers for monitoring and alerting when certain temperatures are reached. Monitor 325 may also be a part of a control loop that opens or shuts values to control the flow of the aqueous liquid based on the temperature readings. It may also control the cooling system 320 based on the temperature readings. Moreover, it may control the timing and speed of the mixer or the sonotrode based on detected temperatures and the process controls as programmed by an operator. Alternatively, the process controls may be implemented as a distributed control network.

Once the aqueous liquid is mixed, it is pumped out of the vessel 313 and into a path 330 with pump 331. A pump as shown in FIG. 6 or as described above may be used in this application. The pump is controlled by controller 332 which may be coupled to monitor 325 or another processor for controlling the amount of flow. Alternatively, it may be manually controlled. The aqueous liquid is pumped into cooling chamber 333 and then into chamber 334 with a sonotrode.

The chambers 333 and 334 may be similar to that shown in FIG. 4. Alternatively, they may each be holding tanks. Once the sonic wave application is completed in chamber 334, the aqueous liquid is pumped back into vessel 313. This process may take from about 2 to about 480 minutes.

In FIG. 5, chamber 333 and 334 are cooled with the cooling system 322 as shown. Although, they may include separate cooling systems, for example as shown in FIG. 4. In one embodiment, using dry-ice and a low-boiling-point liquid such as alcohol, the cooling chamber 333 may lower the temperature of the aqueous liquid to from about −120 Fahrenheit to about −320 Fahrenheit.

The aqueous liquid circulates and recirculates through the system until the desired process time is reached. At the conclusion of that time, a drain at the bottom of vessel 313 may be opened. The liquid drains out of the bottom at 400 into filter 410 as more fully described below.

In one embodiment, pump 331 is used to remove the aqueous liquid from vessel 313. In one embodiment, the pump is an ultra-low shear mechanical pump as described above. The aqueous liquid is directed to filter 410. It moves through filters 410 and 411 which remove the extractions. In the embodiment of FIG. 5, filter 410 may comprise one or more 220 micron filters, and filter 411 may be one or more 73 nano-meter screen. In other embodiments, one or both of the filters 410 and 411 may be coupled to motors (not shown) which vibrate the filters to improve flow and yield. In yet other embodiments only one filter is used. In yet another embodiment, more than two filters are used. The size and order of filters may be chosen to improve sifting and extraction. In FIG. 5, reference number 413 denotes a frame for holding the filter or filters 411.

The extractions are routed to processing centers 500 and 600. In this embodiment, the extractions are freeze-dried at center 500 and then pressed with rosin at 600. For example, cannabis trichomes may be freeze dried at 32 degrees Fahrenheit by removing any remaining moister. In alternative embodiments, the extractions may be directly sold or processed or formed into other consumables, for example, edibles. The extraction may be further purified into terpene components for sale to wholesalers. The extraction may be processed further into vaping products and other inhalables or retail products.

The aqueous liquid remaining after 410 and 411 is routed into containers 412 and 414. The drained liquids from 412 and 414 may be pumped back to vessel 313 for second and subsequent iterations of the process until the desired amount of extractions are separated from the aqueous liquid.

In a process which uses the system and method as illustrated in FIG. 5, the vessel 313 may be chosen, in one embodiment, to hold about 20 gallons of water and about 3-5 pounds of dry, or 2-3 pounds of frozen, plant matter, resulting in about 200-400 grams of rosin product. This result is about a 50% increase in trichome yield by weight of the input material as compared with the method of mixing the plant matter with ice-water and then sifting and filtering the resultant mixture. Using the present method generally increases the trichome extraction yield from about 30% to about 50% as compared with extraction using mixing with ice-water. That is, the trichomes extracted from a given weight of plant matter using the present method or system are about twice that obtained from prior art methods.

The present system and method also decrease process times. In one embodiment, the time for a complete cycle as shown in FIG. 5 is about 8 minutes, prior to further processing at 500, and about one hour until completion of rosin pressing at 600. The typical process time for one batch of mixing with ice-water takes at least 2-3 hours. As would be known to a person having ordinary skill, the yields and process times are dependent on the plant matter, the desired extraction, purity, and other operating parameters. Moreover, the number of operators will increase the speed of processing. In one embodiment, the cycle can be completed in one hour with two operators.

The system may also be fully mechanized with control modules providing the monitoring and control required for optimal performance instead of human operators. Generally, by balancing the flow and the power setting of the sonotrode, as well as the temperature of the liquid before entering the sonotrode, the operator or control can find an optimal balance of desired extraction. With reference to cannabis trichomes, this would be the maximal separation of the trichomes without increasing the presence unwanted byproducts or terpene loss.

What is claimed:

1. A method for removing a substance from its botanical base, the method including the steps of
forming a liquid solution containing the botanical base to create a mixture;
radiating the mixture with sonic waves, in a first phase, in a vessel;
directing the mixture to a second phase wherein solids and liquid are separated from one another to create a separated solid and a remaining liquid; and
redirecting at least a portion of the remaining liquid back to the vessel for reprocessing, wherein the reprocessing includes radiating the remaining liquid with sonic waves.

2. The method according to claim 1 wherein the substance is a trichome.

3. The method according to claim 1 wherein the substance is a terpene.

4. The method according to claim 1 wherein the liquid solution is aqueous.

5. The method according to claim 1 wherein the botanical base comprises portions of a cannabis plant.

6. The method according to claim 1 where at least one of said first or second phases is cooled.

7. The method according to claim 1 wherein the mixture is further subject to mechanical agitation.

8. A method for removing a substance from its botanical base, the method including the steps of
forming an liquid solution containing the botanical base to create a mixture;
radiating the mixture with waves, in a first phase, in a vessel;
directing the mixture to a second phase wherein solids and liquid are separated from one another to create a separated solid and a remaining liquid; and
cooling the mixture prior to the second phase.

9. A method according to claim 8 wherein the mixture is cooled during the radiating.

10. A system for separating a substance from its botanical base comprising:
a vessel;
a wave generator coupled to said vessel;
conduits for directing a liquid mixture to and from said vessel;
filters coupled to said conduits for separating solids from a liquid;
a cooling source coupled to at least said vessel or said conduits;
wherein the vessel and the wave generator are configured to radiate a liquid mixture comprising said liquid and the botanical base.

11. The system according to claim 10 further comprising return conduits for redirecting at least a portion of said liquid back to the wave generator.

12. The system according to claim 11 wherein the redirected liquid is redirected to said vessel.

13. The system according to claim 10 where the wave generator is a sonic wave generator.

14. The system according to claim 10 wherein the wave generator is a sonotrode.

15. The system according to claim 10 wherein the wave generator is an electromagnetic wave generator.

16. The system according to claim 10 wherein the substance is a trichome.

17. The system according to claim 10 wherein the substance is a terpene.

18. The system according to claim 10 wherein the liquid is aqueous.

19. The system according to claim 10 wherein the botanical base comprises portions of a cannabis plant.
